(19) United States
(12) Patent Application Publication
(10) Pub. No.: US 2009/0071210 A1
(43) Pub. Date: Mar. 19, 2009

(54) Combination key and glass scorer

(76) Inventor: Harold Teague, Lumberton, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/901,876

(22) Filed: Sep. 19, 2007

(51) Int. Cl. E05B 19/00

(52) U.S. Cl. 70/405

(57) ABSTRACT

A combination key and window glass scorer is described for use in breaking a vehicle window to enable escape in the event of an accident rendering opening of the vehicle doors or windows impossible. The combination device includes a key body having a head, a shank and an edge; and a window glass scorer attached to the head or shank of the key body. The scorer may be in the form of a rotatable wheel or a fixed scriber, with the scorer being harder on the Mohs hardness scale than the window glass to be scored.

### BACKGROUND OF THE INVENTION

(1) Field of the Invention

The present invention relates to a combination key, such as a vehicle ignition key, and a means to score a vehicle window glass to enable breaking of the glass so that occupants of the vehicle can escape in the event of an accident where the vehicle doors cannot be opened.

(2) Description of the Prior Art

When an automobile or truck, collectively referred to herein as a vehicle, is involved in an accident, it may not be possible for the occupants to open the vehicle to escape if the doors are jammed or the vehicle is underwater. This problem has been recognized by the prior art, and numerous purported solutions have been patented. While various devices have been described, the prior art devices generally require striking of a side or rear vehicle window with the pointed tip of a hand tool to break the window.

These devices may take the form of a hammer-type device that is attached to the vehicle dash or other part of the vehicle interior within reach of the driver, or a tool that includes a key ring so that the tool is carried with the user's keys. These devices are designed for attachment to a key ring and are bulky and can be difficult to carry in a pocket or purse. Therefore, after initial interest, the devices are often no longer carried where they are quickly accessible.

Thus, there remains a need for a convenient, easily carried tool that will enable breaking of a vehicle side or rear window in the event of an emergency, so that the vehicle occupants can escape.

### SUMMARY OF THE INVENTION

Generally, the present invention addresses this need by providing a key of the type that will normally be carried by an individual on a key ring, structurally combined with a means to score a window glass. As used in this application, the term “score” means to create a scratch on the glass sufficient to weaken the structure of the glass and thereby facilitate breaking of the glass. The term “scorer” is intended to encompass any device that will score window glass.

Keys of the type contemplated herein are comprised of a head part to be grasped by the user and an elongated shank part extending from the edge of the head and integral therewith. The shank portion is configured uniquely to the lock that the key fits.

The scorer of the present invention is attached to a part of the key body, either the head or the shank, and extends from the key so that the scorer can be held against the window while the user grasps the key. Preferably, the scorer extends from a side edge of the key.

The scorer can take various forms and be of different constructions, provided that the scorer is harder on the Mohs hardness scale than the glass to be scored. For example, the scorer may have a surface of silicon carbide, diamond or the like, or a steel with a Mohs hardness greater than about 6.0, and preferably greater than 6.5.

In one embodiment, the scorer is in the form of a rotatable wheel with a sharp periphery that is carried of a stub shaft extending through the key, with a portion of the wheel projecting from the key. With this type of scorer, the wheel is rolled across the window glass while as much pressure as possible is applied, creating a score line that penetrates the glass, weakening the glass so that it can be more easily broken.

In another embodiment of the invention, the scorer is in the form of a scriber or projection from the tool that is coated with a grass-abrasive material such as silicon carbide or diamond. For example, the scriber may project from an edge of the key head or from the lower end of the key shank opposite from the key head connection to the shank. With this type of scorer, the scriber portion of the key is drawn across the window glass while under pressure to create the score line.

The combination key and scorer may also include glass gripping means, e.g., notches or recesses along one side of the key head to aid in breaking away glass projections after the glass has been broken.

The key combined with the scorer is preferably the vehicle ignition key for the vehicle with which the scorer might be used. However, it will be understood that the scorer can be combined with other keys, e.g., a house key, office key, trunk key, or other key that is normally carried on the key holder, with the vehicle key, thereby ensuring that the scorer will be readily accessible if needed.

Normally, the device is carried on a key holder and used when required, e.g., as the vehicle's ignition key, in the same manner as a regular key. However, in the event of a vehicle accident where opening of the vehicle's doors is not possible, the user simply holds the scorer, either the wheel or scriber, against the side or rear window and, applying as much pressure as possible, pulls the scorer across the window glass to create a score line, i.e., a hairline fracture in the window glass.

As a result of the fracture, the integrity of the window glass is greatly diminished, permitting the occupant to break the window by kicking the window or by hitting it with his or her fist, or a handy object. In the event that the vehicle is under water, scoring of the window alone will be sufficient to break the window, due the pressure of the water on the outside of the window.

### BRIEF DESCRIPTION OF THE DRAWINGS

FIG. 1 is a front view of one embodiment of a combination key and a glass scorer, with scribers extending from opposite edges of the key head.

FIG. 2 is a front view of a second embodiment of a combination key and glass scorer, with a rotatable scoring wheel projecting from one side of the key head.

FIG. 3 is a front view of a third embodiment of a combination key and glass scorer, with the scorer being in the form of a scriber that is located at the bottom of the key shank.

FIG. 4 is a front view of a fourth embodiment of a combination key and glass scorer in the form of a rotatable scoring wheel projecting from one side of the key head, with the key head further including glass gripping means in the form of a plurality of slots or notches to receive glass to be broken.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

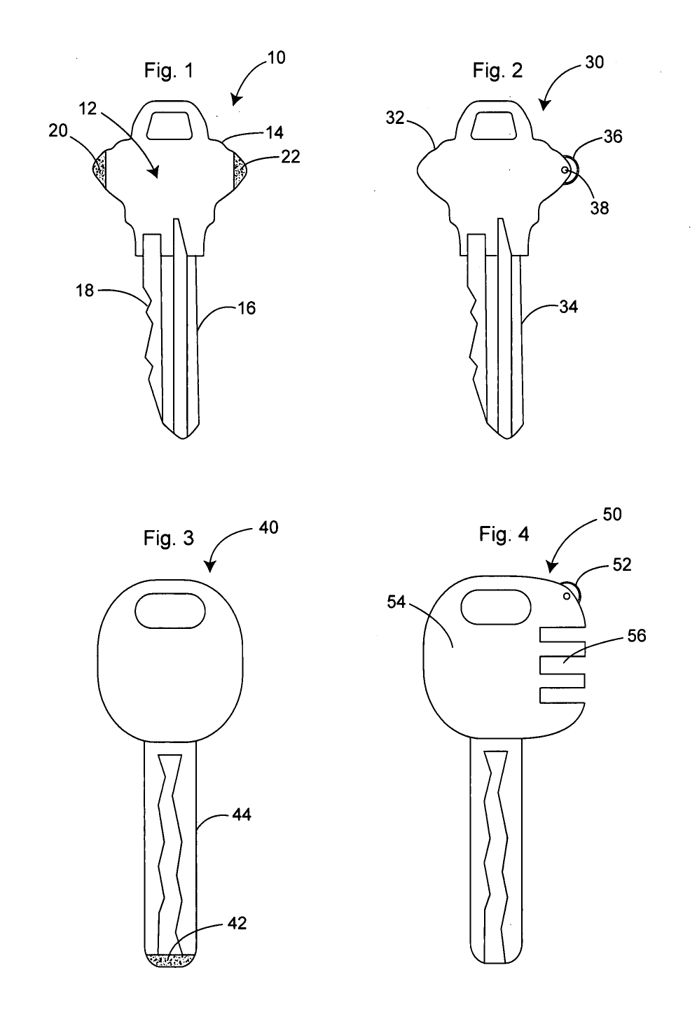

As illustrated in FIG. 1, one embodiment of the combination key and scorer, generally 10, is comprised of a key, generally 12, having a key head 14 with an opening for connecting key 12 to a key holder (not shown), and a shank 16 having a notch pattern 18 along one side of key 12 that is unique to the lock into which key 12 is inserted. Combined tool 10 further includes scorers 20 and 22 that extend outwardly from opposite sides of key head 14 so that either side of key 10 can be used to score a vehicle window. FIG. 2 illustrates a second embodiment of a combination key and glass scorer, generally 30, comprised of a key head 32 and shank 34 with a rotatable scoring wheel 36 projecting from one side of key head 32, and rotatably mounted on shaft 38.

FIG. 3 illustrates a third embodiment of a combination key and glass scorer, generally 40, with the scorer being in the form of scriber 42 that is located at the bottom of key shank 44.

FIG. 4 illustrates a fourth embodiment of a combination key and glass scorer, generally 50. Scorer is in the form of rotatable scoring wheel 52, which projects from one side of key head 54. Key head 54 further includes glass gripping slots or notches 56.

In the event of an accident requiring glass breakage to escape from the vehicle, the user or other vehicle occupant can remove the ignition key from the ignition, and press the scorer on the ignition key or other key carried on the same key holder against a vehicle side or rear window. The scorer is then drawn in a line across the window glass under as much pressure as possible to create a score line, e.g., a hairline fracture in the glass. The occupant can then kick out the window or knock it out with his or her fist or an available object, with breakage of the glass being possible due to the weakening of the glass due to the scoring.

As noted earlier, the present invention may be incorporated into keys other than the ignition key. Since most vehicles now require that the vehicle is in park and the brake is depressed before removing an ignition key, it may be desirable to incorporate the invention into other than the ignition key for ease of access, or provide an ignition key that can break away in an emergency.

Importantly, the tool of the present invention does not take up significantly more space than a key without a scorer, and can be carried and used as a regular key until an emergency arises. Then, as opposed to glass breaking tools that may not be carried in the vehicle due to their bulkiness and inconvenience, the tool of the present invention is always available for emergency use.

Certain modifications and improvements will occur to those skilled in the art upon a reading of the foregoing description. It should be understood that all such modifications and improvements have been deleted herein for the sake of conciseness and readability but are properly within the scope of the following claims.

1. A combination key and window glass scorer comprising:
a) a key body having a head, a shank, glass gripping notches and an edge; and
b) a window glass scoring means attached to said key body.

2. The combination key and window glass scorer of claim 1, wherein said scorer is attached to said key body head.

3. The combination key and window glass scorer of claim 1, wherein said scorer is attached to said key body shank.

4. The combination key and window glass scorer of claim 1, wherein said scorer is comprised of a rotatable cutting wheel.

5. The combination key and window glass scorer of claim 1, wherein said scorer is comprised of a glass abrasive scriber.

6. The combination key and window glass scorer of claim 1, wherein said key body is a vehicle ignition key.

7. (canceled)

8. The combination key and window glass scorer of claim 1, wherein the scorer extends outwardly from the edge of the key body.

9. The combination key and window glass scorer of claim 1, wherein said scorer has a glass contacting surface that is greater than glass on the Mohs hardness scale.

10. A combination key and window glass scorer comprising:
a) a key body having a head, a shank and an edge; and
b) a window glass scorer extending outwardly from the side edge of said key body head.

11. (canceled)

12. The combination key and window glass scorer of claim 10, wherein said key is a vehicle ignition key.

13. The combination key and window glass scorer of claim 10, further including glass gripping notches.

14. (canceled)

15. The combination key and window glass scorer of claim 10, wherein said scorer has a glass contacting surface that is greater than glass on the Mohs hardness scale.

16. A combination key and window glass scorer comprising:
a) a key body having a head, a shank with a bottom, and an edge; and
b) a window glass scriber located at the bottom of the key shank.

17. (canceled)

18. (canceled)

19. The combination key and window glass scorer of claim 16, wherein said key is an automobile key.

20. The combination key and window glass scorer of claim 16, wherein said scorer has a glass contacting surface that is greater than glass on the Mobs hardness scale.
